(19) United States
(12) Patent Application Publication
(10) Pub. No.: US 2024/0075770 A1
(43) Pub. Date: Mar. 7, 2024

(54) SYSTEMS FOR MODULAR AXLE HOUSING

(71) Applicant: Dana Automotive Systems Group, LLC, Maumee, OH (US)

(72) Inventors: Scott L. STEWARD JR., Malinta, OH (US); Steven Thomas BYRNE, Holland, OH (US); Ryan W. LASKEY, Lambertville, MI (US); David G. MOSES, Kalamazoo, MI (US); Benjamin J. PASSINO, Maumee, OH (US)

(21) Appl. No.: 17/929,224

(22) Filed: Sep. 1, 2022

(51) Int. Cl. B60B 35/16; B60B 35/12; B60K 17/16

(52) U.S. Cl. CPC B60B 35/163; B60B 35/125; B60B 35/166; B60K 17/165

(57) ABSTRACT

Systems are provided for an axle housing for a vehicle. In one example, system includes a differential housing comprising a modular Salisbury style center section comprising tube mounts configured to receive tube assemblies via a press fit.

### TECHNICAL FIELD

The present description relates generally to an axle assembly in a vehicle.

### BACKGROUND AND SUMMARY

Axle assemblies are adapted to transmit rotational power from an engine of a vehicle to the wheels thereof. Typically, an axle assembly includes a differential assembly that is rotatably supported within a non-rotating housing (e.g., carrier). The differential is connected between an input drive shaft extending from the vehicle engine/transmission and a pair of output axle shafts extending to the vehicle wheels. The axle shafts are contained in respective non-rotating beam housing portions (e.g., axle tubes), which are secured to a central housing. Thus, rotation of the differential by the drive shaft causes corresponding rotation of the axle shafts. The central housing and the beam housing portions form an axle housing for these drive train components of the axle assembly, with the differential and the axle shafts supported for rotation therein.

One type of axle housing includes a unitized central housing construction, commonly referred to as a Salisbury or Spicer type (or style) axle assembly. In this structure, the central housing (which houses the differential assembly) is directly connected to the two beam housing portions (which house the rotatable axle shafts). An opening is provided at the rear of the central housing to permit assembly of the differential therein. A cover closes this opening during use.

Another type of axle housing includes a separable central housing construction. In this structure, the axle beam housing portions are connected together by a central portion of the axle housing that is formed separate and apart from a differential carrier. This central portion is generally hollow and cylindrical in shape, having a large generally circular opening formed therethrough. The overall shape of this type of axle housing (e.g., the generally round shape of the central portion and the elongated beam housing portions extending therefrom) generally resembles the shape of a banjo musical instrument. Hence, this type of axle housing is commonly referred to as a banjo type axle housing. In addition, the beaming loads of the vehicle weight are carried via a separate structure from that which orients and rotatably supports the differential assembly. Because of this separation of function, banjo-style axles are adapted to support higher vehicle weights than a Salisbury style axle assembly of similar size. However, the Salisbury style housing may have reduced lubrication usage due to the unitized central housing, which is sealed internally. As such, both types of axle housing assemblies may have drawbacks and benefits.

In one example, the issues described above may be addressed by a system including a differential housing comprising a modular Salisbury style center section comprising tube mounts configured to receive tube assemblies via a press fit. In this way, the wall thicknesses of the tube mounts may be adjusted while maintaining a common center section across a variety of vehicles comprising different vehicle loads.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

The above, as well as other advantages of the present disclosure, will become readily apparent to those skilled in the art from the following detailed description when considered in light of the accompanying drawings in which:

FIG. 1 is a schematic depiction of an example vehicle powertrain;

FIG. 2 shows a perspective view of a vehicle axle assembly;

FIG. 3A shows a front perspective view of a modular central portion of an axle housing;

FIG. 3B shows a partial front perspective view of the modular central portion of the axle housing; and

FIG. 3C shows a back perspective view of the modular central portion of the axle housing.

### DETAILED DESCRIPTION

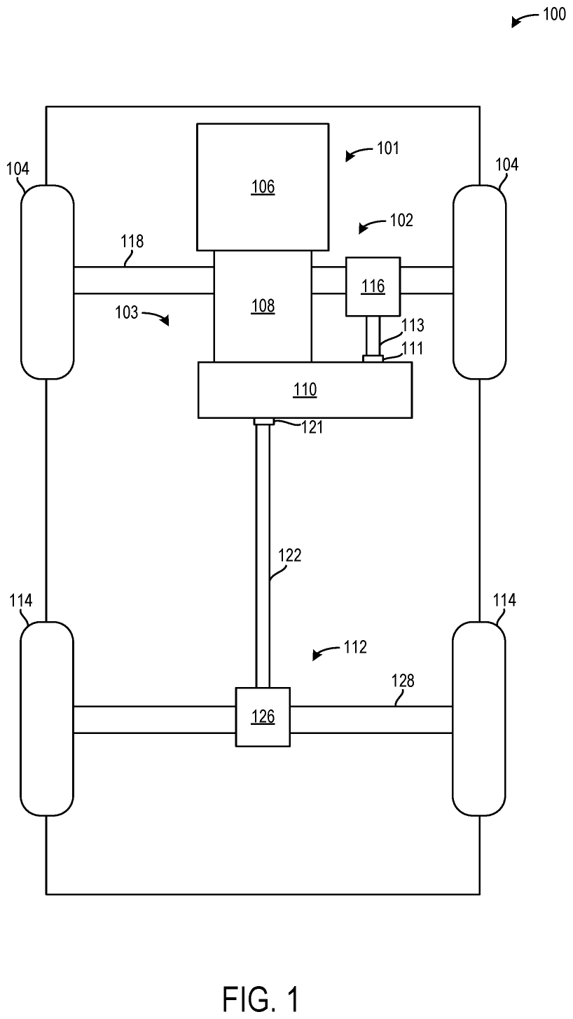

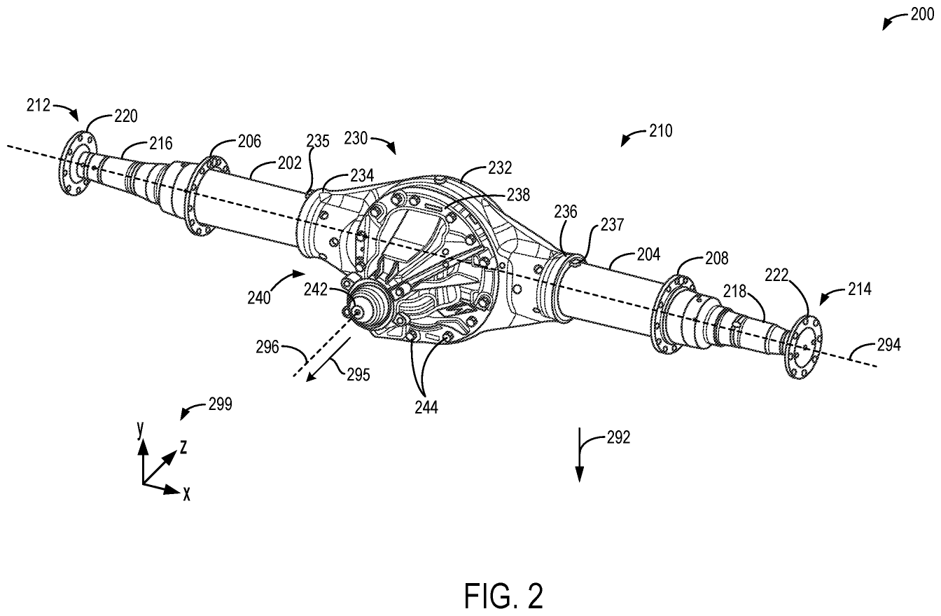

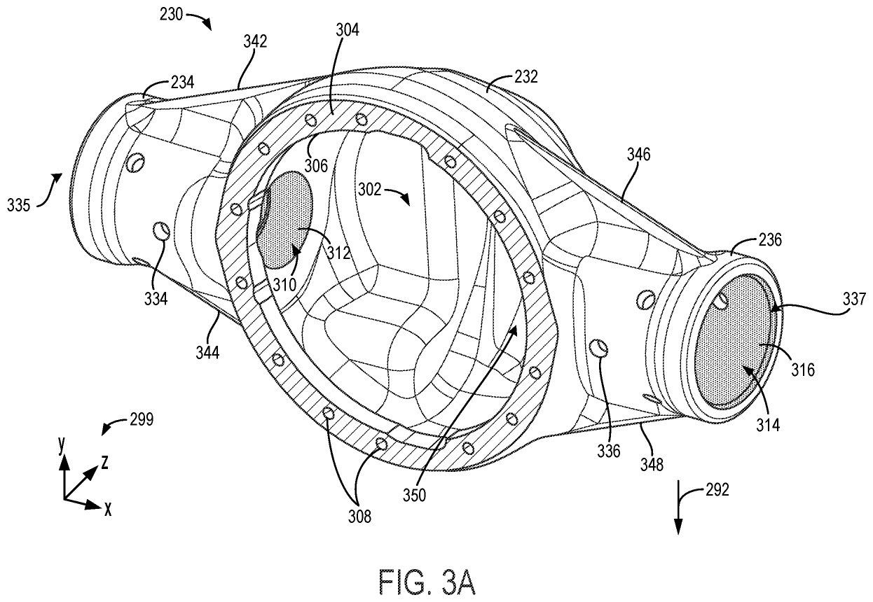

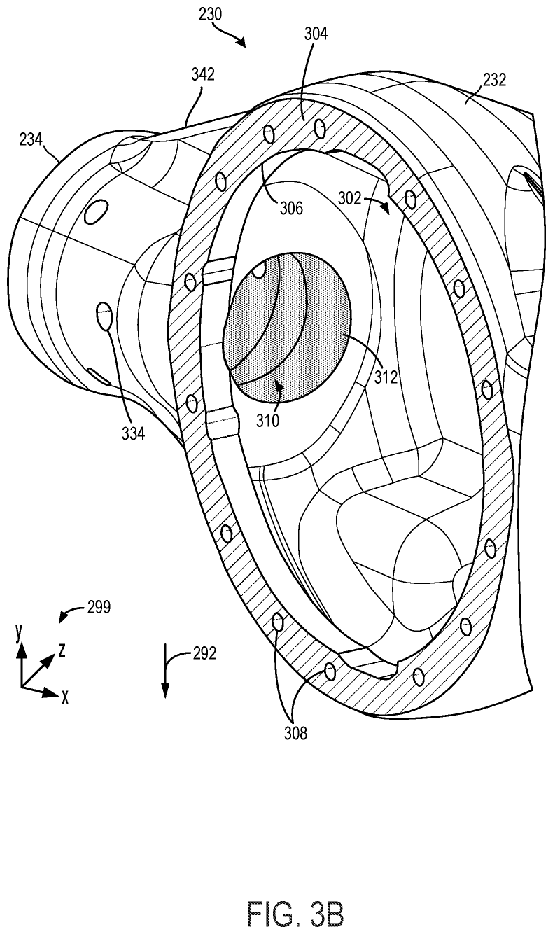

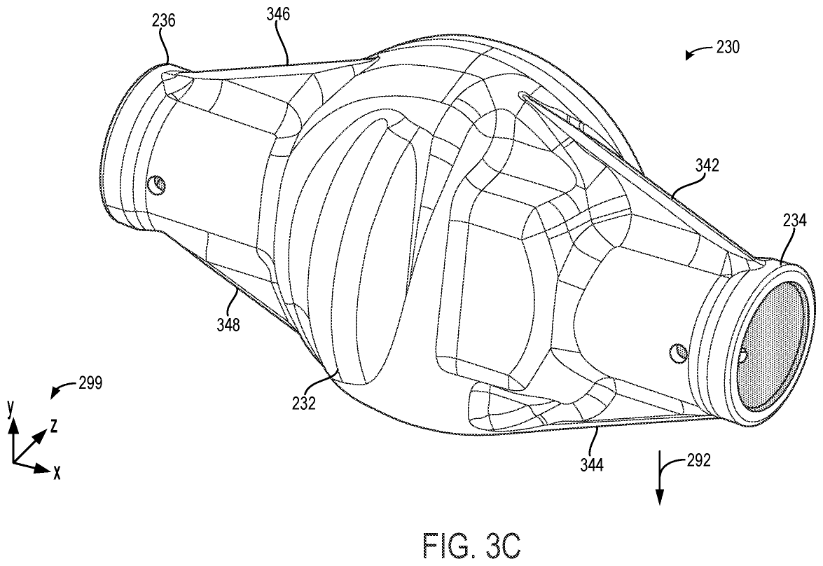

The following description relates to a system for an axle assembly in a vehicle. For example, the vehicle may be propelled by a powertrain, such as illustrated in FIG. 1. The powertrain may include at least one axle assembly, such as depicted in FIG. 2. The axle assembly may include a modular central housing, various views of which are illustrated in FIGS. 3A-3C. For example, the modular central housing may be adapted for varying tube wall thicknesses while reducing lubrication demands due to internal sealing. FIGS. 2-3C are shown approximately to scale. However, alternative dimensions may be used if desired.

Turning now to FIG. 1, a vehicle 100 is shown comprising a powertrain 101 and a drivetrain 103. The powertrain comprises a prime mover 106 and a transmission 108. The prime mover 106 may be an internal combustion engine or an electric motor, for example, and is operated to provide rotary power to the transmission 108. The transmission 108 may be any type of transmission, such as a manual transmission, an automatic transmission, or a continuously variable transmission. The transmission 108 receives the rotary power produced by the prime mover 106 as an input and outputs rotary power to the drivetrain 103 in accordance with a selected gear or setting.

In some examples, such as shown in FIG. 1, the drivetrain 103 includes a first axle assembly 102 and a second axle assembly 112. The first axle assembly 102 may be configured to drive a first set of wheels 104, and the second axle assembly 112 may be configured to drive a second set of wheels 114. In one example, the first axle assembly 102 is arranged near a front of the vehicle 100 and thereby comprises a front axle, and the second axle assembly 112 is arranged near a rear of the vehicle 100 and thereby comprises a rear axle. The drivetrain 103 is shown in a four-wheel drive configuration, although other configurations are possible. For example, the drivetrain 103 may include a front-wheel drive, a rear-wheel drive, or an all-wheel drive configuration. Further, the drivetrain 103 may include one or more tandem axle assemblies. As such, the drivetrain 103 may have other configurations without departing from the scope of this disclosure, and the configuration shown in FIG. 1 is provided for illustration, not limitation. Further, the vehicle 100 may include additional wheels that are not coupled to the drivetrain 103.

In some four-wheel drive configurations, such as shown in FIG. 1, the drivetrain 103 includes a transfer case 110 configured to receive rotary power output by the transmission 108. A first driveshaft 113 is drivingly coupled to a first output 111 of the transfer case 110, while a second driveshaft 122 is drivingly coupled to a second output 121 of the transfer case 110. The first driveshaft 113 (e.g., a front driveshaft) transmits rotary power from the transfer case 110 to a first differential 116 of the first axle assembly 102 to drive the first set of wheels 104, while the second driveshaft 122 (e.g., a rear driveshaft) transmits the rotary power from the transfer case 110 to a second differential 126 of the second axle assembly 112 to drive the second set of wheels 114. For example, the first differential 116 is drivingly coupled to a first set of axle shafts 118 coupled to the first set of wheels 104, and the second differential 126 is drivingly coupled to a second set of axle shafts 128 coupled to the second set of wheels 114. It may be appreciated that each of the first set of axle shafts 118 and the second set of axle shafts 128 may be positioned in a housing. An embodiment of an axle assembly will be described in more detail below with respect to FIGS. 2-3C

In some examples, additionally or alternatively, the vehicle 100 may be a hybrid vehicle including both an engine an electric machine each configured to supply power to one or more of the first axle assembly 102 and the second axle assembly 112. For example, one or both of the first axle assembly 102 and the second axle assembly 112 may be driven via power originating from the engine in a first operating mode where the electric machine is not operated to provide power (e.g., an engine-only mode), via power originating from the electric machine in a second operating mode where the engine is not operated to provide power (e.g., an electric-only mode), and via power originating from both the engine and the electric machine in a third operating mode (e.g., an electric assist mode). As another example, one or both of the first axle assembly 102 and the second axle assembly 112 may be an electric axle assembly configured to be driven by an integrated electric machine.

As mentioned above, axle assemblies (e.g., the first axle assembly 102 and the second axle assembly 112 of FIG. 1) are configured to transfer power originating from a prime mover of a vehicle to wheels of the vehicle. However, it may be difficult to adapt existing axle assemblies to different vehicle load capacities and vehicle weights while increasing assembly efficiency. For example, Salisbury-style axle assemblies may have increased efficiency and reduced lubrication demands due having an internally sealed central housing, while banjo-style axle assemblies may be adapted to support higher vehicle weights than a Salisbury-style axle assembly of similar size due to having a separate structure for supporting beaming loads. However, the banjo-style axle assembly may have increased lubrication demands compared with the Salisbury-style axle assembly.

Thus, with reference to FIGS. 2-3C, components of a modular axle assembly that may be adapted for different vehicle loads while decreasing lubrication demands are shown. FIGS. 2-3C show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing.

Further, reference axes 299 are provided throughout FIGS. 2-3C in order to compare the relative orientations of the various views. The reference axes 299 include an x-axis parallel to a horizontal axis, a y-axis parallel to a vertical axis, and a z-axis parallel to a transverse axis and normal to each of the x- and y-axes. A direction of gravity is illustrated via an arrow 292. Where applicable, smaller line width contour lines are provided to generally indicate depth and three-dimensional forms. Throughout FIGS. 2-3C, like components are numbered the same and will not be re-introduced.

Referring first to FIG. 2, a front perspective view 200 of a drive axle 210 is shown. The drive axle 210 includes a central axis 294, which is parallel to the x-axis of the reference axes 299. The drive axle 210 may be a non-limiting example of the first axle assembly 102 or the second axle assembly 112 of FIG. 1. In an embodiment, the drive axle 210 is a rear axle, and thus, the drive axle 210 may be the second axle assembly 112 of FIG. 1. The central axis 294 may be an axis of rotation for a first axle shaft 212 and a second axle shaft 214 of the drive axle 210. The first axle shaft 212 and the second axle shaft 214 may be configured to mount to and rotate vehicle wheels, such as the second wheel set 114 of FIG. 1. For example, the first axle shaft 212 and the second axle shaft 214 are arranged at opposite ends of the drive axle 210 and each comprise a terminal hub that may be used to mount the vehicle wheels. The first axle shaft 212 includes a first hub 220, and the second axle shaft 214 includes a second hub 222.

The drive axle 210 further comprises a central housing 230 that houses a differential 240. Herein, the central housing 230 may be interchangeably referred to as a carrier 230. The central housing 230 comprises a body portion 232 having a first tube mount 234 on a first end of the body portion 232 and a second tube mount 236 on a second end of the body portion 232 that is opposite the first end relative to the central axis 294. As one example, the body portion 232 may be a singular piece die cast of metal, including one or more of aluminum, steel, cast iron, or the like. In some examples, the first tube mount 234 may be larger (or smaller) than the second tube mount 236. For example, the first tube mount 234 may have a larger (or smaller) diameter and/or a longer (or shorter) length along the central axis 294 compared with the second tube mount 236. In other examples, the first tube mount 234 and the second tube mount 236 may be equal in size. In one example, a wall thickness of the first tube mount 234 and the second tube mount 236 may be adjusted based on a vehicle load. The carrier 230 shape may be maintained even when the wall thicknesses of the tube mounts are adjusted. By doing this, research and manufacturing costs for a vehicle manufacturer are reduced across a vehicle fleet comprising vehicles with different vehicle loads.

The differential 240 may receive input from a driveshaft (e.g., the second driveshaft 122 of FIG. 1) via a pinion 242, which may rotate along an axis 296 that is perpendicular to the central axis 294 and parallel to the z-axis of reference axes 299. The pinion 242 may extend through a cover portion 238 of the central housing 230, which is removably coupled to the body portion 232 via a plurality of fasteners 244. The plurality of fasteners 244 may include one or more of bolts, screws, lugs, or the like arranged around a circumference of the cover portion 238 and the body portion 232. As one example, the cover portion may be die cast of same or different material as the body portion 232 of the central housing 230. As will be described below with respect to FIGS. 3A-3C, the body portion 232 may be a singular, continuous piece having a cavity for housing the differential 240 with openings only at the first tube mount 234, the second tube mount 236, and where the cover portion 238 is attached.

An assembly direction is shown via arrow 295, which is parallel to axis 296, wherein gears are arranged externally to the body portion 232 in the assembly direction. An assembly split line seam of the axle assembly may be arranged between the cover portion 238 and the body portion 232. There may be no other seams or other coupling points with regard to the central housing 230. As such, the assembly split line seam may be the only assembly seam arranged between the cover and the center section of the housing.

The first tube mount 234 of the body portion 232 is arranged on a side of the differential 240 biased toward the first axle shaft 212, while the second tube mount 236 of the body portion 232 is arranged on a side of the differential 240 biased toward the second axle shaft 214. An axle track of the drive axle 210 that houses the first axle shaft 212 and the second axle shaft 214 may be defined via a first axle tube 202 and a second axle tube 204, which are concentric about the central axis 294. The first axle tube 202 may be pressed into the first tube mount 234 of the body portion 232. The second axle tube 204 may be pressed into the second tube mount 236 of the body portion 232. That is, at least a portion of the first axle tube 202 may be positioned inside of the first tube mount 234 of the first body portion 232 so that an exterior surface of the first tube mount 234 is in face-sharing contact with an interior surface of the first tube mount 234 of the body portion 232, as will be elaborated below with respect to FIGS. 3A and 3B. Similarly, at least a portion of the second axle tube 204 may be pressed inside the second tube mount 236 so that an exterior surface of the second axle tube 204 may be in face-sharing contact with interior surfaces of the second tube mount 236 of the body portion 232. The first axle tube 202 and the second axle tube 204 may be fixedly coupled to the corresponding tube mount of the body portion 232, such as puddle welded in place.

The first axle tube 202 and the second axle tube 204 may comprise a cylindrical shape, such as shown in FIG. 2, including a central cavity configured to house the corresponding axle shaft. However, other shapes are possible, such as square boxed tube. In some examples, the first axle tube 202 and the second axle tube 204 may have substantially identical dimensions. In other examples, the length and/or diameter of the first axle tube 202 and the second axle tube 204 may be different from each other. For example, the first axle tube 202 may have a longer (or shorter) length than the second axle tube 204. Additionally or alternatively, the first axle tube 202 may have a greater (or smaller) diameter than the second axle tube 204.

Further, each of the first axle tube 202 and the second axle tube 204 includes a wall thickness between an inner surface defining the central cavity and the outer surface. The wall thickness of the first axle tube 202 and the second axle tube 204 may vary based on vehicle load demands. The body portion 232 of the central housing 230 may be adapted to accommodate axle tubes having varying wall thicknesses. For example, the same body portion 232 may be used for axle tubes having smaller wall thicknesses and larger wall thicknesses due to the pressed in and welded joint between each axle tube and the corresponding tube mount of the body portion 232, such as described above. As a result, the body portion 232 may provide a modular housing that may be adapted for a plurality of different drive axles, each configured for a different vehicle load demand. By including larger tube wall thicknesses for vehicles having higher vehicle load demands, axle durability may be increased for increased vehicle durability. By including smaller tube wall thicknesses for vehicles having smaller vehicle load demands, vehicle weight may be decreased for increased vehicle efficiency. In some examples, a shim or other material may be used in combination with axle tubes comprising smaller diameters such that the central housing 230 configuration may be maintained across different vehicle types.

Continuing with FIG. 2, the first axle shaft 212 may be positioned to rotate within the first axle tube 202. The second axle shaft 214 may be positioned to rotate within the second axle tube 204. The first axle shaft 212 may extend though the first tube mount 234 to the differential 240, where the first axle shaft 212 may be engaged with a gear set (e.g., a planetary gear set) of the differential 240. Similarly, the second axle shaft 214 may extend into the second tube mount 236 of the body portion 232, wherein the second axle shaft 214 may engage with the second planetary gear set. In this way, the first axle shaft 212 may provide a first rotational speed to the first hub 220 and a wheel mounted thereon and the second axle shaft 214 may provide a second rotational speed, different or equal to the first rotational speed, to the second axle shaft 222 and a wheel mounted thereon. In one example, the speeds may be differentiated via adjusting a gearing of the differential or of the planetary gear sets, which may provide torque vectoring or other all-wheel drive capabilities.

The first axle shaft 212 may further extend through a first spindle 216 that is coupled to the first axle tube 202, and the second axle shaft 214 may extend through a second spindle 218 that is coupled to the second axle tube 204. Together, the axle tubes 202 and 204 and the spindles 216 and 218 may provide an axle housing. The first spindle 216 may be removably coupled to the first axle tube 202, and the second spindle 218 may be removably coupled to the second axle tube 204. The spindles 216 and 218 may rotatably support the wheels of the vehicle on the axle housing while allowing the axle shafts to extend therethrough to rotatably drive the wheels. Although not shown in FIG. 2, brake system components may be positioned around and mounted to the first spindle and the second spindle 218. Further, vehicle mounts may be positioned around the axle tubes 202 and 204 and/or the spindles 216 and 218, such as removably coupled to a first bracket 206 of the first axle tube 202 and a second bracket 208 of the second axle tube 204. The vehicle mounts may be used to physically couple the drive axle 210 to an underside of the vehicle, for example.

It may be understood that various bearings, gaskets, sealing rings (e.g., o-rings and snap rings), joints, washers, nuts, shims, and other components may be included in the drive axle 210 in order to facilitate the rotation of various components (e.g., the axle shafts 212 and 214, the pinion 242, and other differential components) as well as provide sealing for lubrication.

Referring now to FIGS. 3A-3C, a front perspective view (FIG. 3A), a partial front perspective view (FIG. 3B), and a back perspective view (FIG. 3C) of the central housing 230 are shown. FIGS. 3A-3C are described in tandem herein.

The central housing 230 may include an interior 302 visible through an opening 306. A rim 304 may circumferentially surround the opening 306, wherein the rim 304 may include a plurality of openings 308. The plurality of openings 308 may include threads or other engaging features configured to receive the plurality of fasteners (e.g., the plurality of fasteners 244 of FIG. 2). The cover portion (e.g., cover portion 238) may seal the interior 302 of the central housing 230.

A first tube side 310 may include a first tube passage 312 interior to the first tube mount 234. The first axle tube (e.g., first axle tube 202) may extend through the first tube passage 312 toward the interior 302. In one example, the first tube passage 312 may include one or more features, such as a dam, ribs, or other feature configured to alter a flow of lubricant. The first axle tube may be blocked from extending into the interior 302 via the first stop (e.g., first stop 235 of FIG. 2).

A second tube side 314 may include a second tube passage 316 interior to the second tube mount 236. The second axle tube (e.g., the second axle tube 204) may extend through the second tube passage 316 toward the interior 302. In one example, the second tube passage 316 may include one or more features, such as a dam, ribs, or other feature configured to alter a flow of lubricant. The second axle tube may be blocked from extending into the interior 302 via the second stop (e.g., second stop 237 of FIG. 2).

In this way, each of the first axle tube and the second axle tube may be press fit into the first tube mount 234 and the second tube mount 236 respectively. The first and second axle tubes may be fixed in place via one or more of a fastener, an adhesive, a weld, a fusion, or the like. In one example, the first axle tube and the second axle tube are puddle welded in place.

The first tube mount 234 may further include a plurality of first openings 334 and the second tube mount 236 may include a plurality of second openings 336. The plurality of first openings 334 and the plurality of second openings 336 may be configured to admit lubricant to and/or expel lubricant from the first axle tube and the second axle tube, respectively. The plurality of first openings 334 and the plurality of second openings 336 may be arranged on a front face of the first tube mount 234 and the second tube mount 236.

The first tube mount 234 may further include a first opening 335. The second tube mount 236 may further include a second opening 337. The first opening 335 and the second opening 337 may be arranged on a back face of the first tube mount 234 and the second tube mount 236. The first opening 335 may be opposite the plurality of first openings 334. The second opening 337 may be opposite the plurality of second openings 336.

The plurality of first openings 334 may include three openings arranged in a triangular shape, wherein the first opening 335 is aligned with only one of the plurality of first openings 334 along the z-axis. The plurality of second openings 336 may include three openings arranged in a triangular shape, wherein the second opening 337 is aligned with only one of the plurality of second openings 336 along the z-axis.

The housing 230 may include a plurality of ribs and lube channels arranged therein. The ribs and lube channels may reduce churn losses and increase overall efficiency by decreasing friction experienced therein. The housing 230 may include a first upper rib 342 and a first lower rib 344 coupled to the first tube mount 234. The housing 230 may further include a second upper rib 346 and a second lower rib 348. The ribs may be oriented in a direction parallel to the x-axis. In one example, the ribs may support a vertical axle load. A size of the ribs may be adjusted based on the vertical axle load, wherein the ribs are larger when the vertical axle load of the vehicle is higher relative to other vehicles.

The first upper rib 342 and the first lower rib 344 may include a triangular shape and extend from the first tube mount 234 to a carrier (e.g., the central housing 230). The second upper rib 346 and the second lower rib 348 may include a triangular shape and extend from the second tube mount 236 to the carrier. In one example, a size and a shape of the ribs are identical to one another.

A plurality of main lube channels 350 may be arranged in the carrier, which is mounted into the modular housing. The plurality of main lube channels 350 may be case into a cover side of the housing aligned with a ring gear. The cast banjo style carrier may be configured to optimize oil volume and reduce churn losses.

In one example, the axle assembly include a Salisbury type arrangement along with the Banjo style carrier where the housing is formed and gears are mounted externally to a center section of the housing. The Banjo style housing may include press up tubes, thereby allowing the housing to be coupled to existing carrier assemblies that mount to traditional stamped Banjo housings. The cast housing canter may support a plurality of different tube and carrier assembly configurations, such as tube assemblies with Salisbury axle assemblies.

The disclosure provides support for a system including a differential housing comprising a modular Salisbury style center section comprising tube mounts configured to receive tube assemblies via a press fit. A first example of the system further includes where the differential housing is a banjo style housing where the center section comprises a round shape and the tube mounts comprise an elongated shape. A second example of the system, optionally including the first example, further includes a plurality of ribs comprising a triangular shape, wherein each of the plurality of ribs is physically coupled to the center section and one of the tube mounts. A third example of the system, optionally including one or more of the previous examples, further includes where each of the tube assemblies is puddle welded to one of the tube mounts. A fourth example of the system, optionally including one or more of the previous examples, further includes where the differential housing is arranged in a variety of vehicles with different vehicles loads, wherein the center section is identical in each of the variety of vehicles. A fifth example of the system, optionally including one or more of the previous examples, further includes where a size of one or more of the tube mounts and the tube assemblies are adjusted in each of the variety of vehicles. A sixth example of the system, optionally including one or more of the previous examples, further includes where an assembly direction is normal to a central axis of a drive axle.

The disclosure provides additional support for an axle assembly including a modular differential housing comprising a first tube mount and a second tube mount, wherein a center section of the housing comprises a round shape and the first tube mount and the second tube mount comprise elongate shapes. A first example of the axle assembly further includes where the housing comprises a single assembly split line seam. A second example of the axle assembly, optionally including the first example, further includes where gears are mounted externally to the center section. A third example of the axle assembly, optionally including one or more of the previous examples, further includes where the housing comprises a central opening surrounded by a plurality of openings, and wherein a cover is physically coupled to the central opening via a plurality of fasteners engaging with the plurality of openings. A fourth example of the axle assembly, optionally including one or more of the previous examples, further includes where axle arms are press fit into each of the first tube mount and the second tube mount. A fifth example of the axle assembly, optionally including one or more of the previous examples, further includes where the axle arms are puddle welded to the first tube mount and the second tube mount. A sixth example of the axle assembly, optionally including one or more of the previous examples, further includes where the first tube mount and the second tube mount receive square boxed tube axle arms. A seventh example of the axle assembly, optionally including one or more of the previous examples, further includes where the axle assembly is coupled to a rear drive unit or a front drive unit of a vehicle.

The disclosure provides further support for an axle assembly for an electric vehicle including a modular differential housing comprising a first tube mount and a second tube mount flanking a center section, wherein the center section comprises a round shape and the first tube mount and the second tube mount comprise elongate shapes and ribs physically coupled to the center section and one of the first tube mount and the second tube mount. A first example of the axle assembly further includes where gears are mounted externally to the center section, and wherein an assembly direction of the axle assembly is normal to a central axis of one or more axle arms. A second example of the axle assembly, optionally including the first example, further includes where the one or more axle arms are press fit into the first tube mount and the second tube mount. A third example of the axle assembly, optionally including one or more of the previous examples, further includes where a wall thickness of the first tube mount and the second tube mount are adjusted based on a vehicle load. A fourth example of the axle assembly, optionally including one or more of the previous examples, further includes where the axle assembly comprises only one assembly split line seam arranged between an opening of the center section and a housing cover.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A system, comprising:
a differential housing comprising a modular Salisbury style center section comprising tube mounts configured to receive tube assemblies via a press fit.

2. The system of claim 1, wherein the differential housing is a banjo style housing where the center section comprises a round shape and the tube mounts comprise an elongated shape.

3. The system of claim 1, further comprising a plurality of ribs comprising a triangular shape, wherein each of the plurality of ribs is physically coupled to the center section and one of the tube mounts.

4. The system of claim 1, wherein each of the tube assemblies is puddle welded to one of the tube mounts.

5. The system of claim 1, wherein the differential housing is arranged in a variety of vehicles with different vehicles loads, wherein the center section is identical in each of the variety of vehicles.

6. The system of claim 5, wherein a size of one or more of the tube mounts and the tube assemblies are adjusted in each of the variety of vehicles.

7. The system of claim 1, wherein an assembly direction is normal to a central axis of a drive axle.

8. An axle assembly, comprising:
a modular differential housing comprising a first tube mount and a second tube mount, wherein a center section of the housing comprises a round shape and the first tube mount and the second tube mount comprise elongate shapes.

9. The axle assembly of claim 8, wherein the housing comprises a single assembly split line seam.

10. The axle assembly of claim 9, wherein gears are mounted externally to the center section.

11. The axle assembly of claim 8, wherein the housing comprises a central opening surrounded by a plurality of openings, and wherein a cover is physically coupled to the central opening via a plurality of fasteners engaging with the plurality of openings.

12. The axle assembly of claim 8, wherein axle arms are press fit into each of the first tube mount and the second tube mount.

13. The axle assembly of claim 12, wherein the axle arms are puddle welded to the first tube mount and the second tube mount.

14. The axle assembly of claim 8, wherein the first tube mount and the second tube mount receive square boxed tube axle arms.

15. The axle assembly of claim 8, wherein the axle assembly is coupled to a rear drive unit or a front drive unit of a vehicle.

16. An axle assembly for an electric vehicle, comprising:
a modular differential housing comprising a first tube mount and a second tube mount flanking a center section, wherein the center section comprises a round shape and the first tube mount and the second tube mount comprise elongate shapes; and
ribs physically coupled to the center section and one of the first tube mount and the second tube mount.

17. The axle assembly of claim 16, wherein gears are mounted externally to the center section, and wherein an assembly direction of the axle assembly is normal to a central axis of one or more axle arms.

18. The axle assembly of claim 17, wherein the one or more axle arms are press fit into the first tube mount and the second tube mount.

19. The axle assembly of claim 16, wherein a wall thickness of the first tube mount and the second tube mount are adjusted based on a vehicle load.

20. The axle assembly of claim 16, wherein the axle assembly comprises only one assembly split line seam arranged between an opening of the center section and a housing cover.
